(19) United States
(12) Patent Application Publication
(10) Pub. No.: US 2010/0226201 A1
(43) Pub. Date: Sep. 9, 2010

(54) Disassemblable, removable ice dispenser agitator

(75) Inventors: David K. Njaastad, Palatine, IL (US); Wieslaw Tomczyk, Wheeling, IL (US)

Correspondence Address: PYLE & PIONTEK LLC, 221 N. LASALLE STREET, SUITE 1207, CHICAGO, IL, 60601, US

(73) Assignee: IMI Cornelius, Inc.

(21) Appl. No.: 12/660,784

(22) Filed: Mar. 4, 2010

Related U.S. Application Data
(60) Provisional application No. 61/209,335, filed on Mar. 5, 2009.

(51) Int. Cl. B01F 7/00

(52) U.S. Cl. 366/331

(57) ABSTRACT

A multiple piece agitator for an ice dispenser, which could also include a beverage dispenser, having an ice bin with a limited access opening, is disclosed. The multiple piece agitator can be easily field disassembled within the dispenser's ice bin, then the agitator disassembled pieces removed for cleaning or servicing of the ice bin in which the agitator moves and/or for cleaning or servicing the agitator. The invention lessens the need to remove any icemaker, usually fitted to the ice dispenser, before servicing of the ice bin and/or agitator.

### DISCLOSURE

This application is a continuation-in-part United States Non-Provisional Patent Application claiming priority of U.S. Provisional Patent Application Ser. No. 61/209,335, filed Mar. 5, 2009, and relates to an agitator, method of constructing the same, an ice dispenser and multiple piece agitator for the same, a method for removing and installing the agitator for service, and a method for using the same, and more particularly to a disassemblable agitator of multiple piece construction that can be removed and installed from a limited space service or access opening of the ice dispenser.

### BACKGROUND OF THE INVENTION

Ice dispensers, be it for dispensing ice or in combination with other structure for dispensing beverages, usually comprise an ice bin with an opening for filling the same and an opening for discharging the ice therein, therefrom. Ice shall mean, unless otherwise stated herein, all forms of dispensable ice (including in the form of cubes, crushed ice, etc.). As used herein the term “ice dispenser” would also include a beverage dispenser having an ice dispenser. To keep the ice from freezing up or agglomerating during periods of use and nonuse, the ice is agitated by a power driven, usually by an electric motor, agitator. These agitators were of a similar unitary construction, made of metal and made from a single piece or several pieces welded together into a single piece, due to the high stresses imposed on the agitator as it was required as it moved to break up frozen clumps of ice. See FIGS. 1 and 2.

During the build up of the dispenser, which may also included an icemaker mounted on top of the dispenser's ice bin, it was relatively easy to install the agitator on the motor shaft before the icemaker was installed on top. However, in the field, in a restaurant, service station, store etc., the icemaker mounted on top of the dispenser's ice bin, greatly closed off the access or service to the agitator. In some installations the building's ceiling limited space above the top mounted icemaker.

Various sanitation and health codes require that the ice dispenser and its components, including the ice bin and agitator therein be cleaned and sanitized with regularity.

In many circumstances in order to access the ice bin and agitator, the icemaker had to be physically moved or removed. The icemaker removal was a daunting task, as the icemaker was heavy, say from 150 to 300 pounds, and bulky, say from 14 to 25 inches in length, 25 to 44 inches in width, and 30 to 40 inches in height. Generally it required at least two persons to safely remove the icemaker to access the interior of the ice bin and remove and clean and service a prior art unitary agitator. Another approach lets the maintenance person reach his hands inside and try to clean the interior of the bin and also the agitator, but generally with this approach the agitator could not be totally removed from the bin. Maintenance was a difficult task to do, and at best sometimes the prior art agitator could be dismounted from its shaft, but due to its size and unitary construction could only be awkwardly moved about or around while still within the bin, while trying to clean and sanitize the agitator and/or the bin. Further, as the icemaker is frequently stacked on top of the ice dispenser, the building ceiling height sometimes even limited how far the icemaker could be lifted off of the ice dispenser for cleaning or servicing of the ice bin and/or agitator.

Further, on occasion the agitator was bent and needed to be straightened, repaired or replaced. These tasks too were difficult with the limited access and the prior art unitary constructed agitators. These acts of repair or replacement frequently required the icemaker to be taken off the dispenser in order to remove the agitator for repair or replacement.

### BRIEF SUMMARY OF THE INVENTION

In the present invention the ice dispenser, and if equipped icemaker combination, is provided with a disassemblable agitator which fits within the ice bin of the dispenser and below the icemaker. See FIGS. 3 to 5. To accomplish this, the agitator is made in several pieces, and each of the pieces are such that the agitator can be disassembled or placed in the bin and physically are small enough when the agitator is disassembled to be removed from the limited service or access opening (say from about 6.9 inches by 25 to 44 inches) of the dispenser. See page 2 hereof and FIGS. 5 and 6A, B and C. Further, the piece making up the agitator needs no fasteners to hold it together, the action of the ice on the moving agitator doing so. Thus, the need to remove the icemaker when cleaning or servicing the agitator and/or sanitizing or servicing the ice bin the agitator fits into, is avoided.

As the disassembleable, removable agitator makes it easier to sanitize and clean both the agitator parts and the bin, these steps are more likely frequently and easily accomplished. To this end, the size and configuration of each of the pieces of the multi-piece agitator of the present invention is formed (none bigger than 16×3×14.25 inches) so that it, or all pieces, can also fit more easily into a conventional domestic or commercial dish washer.

The agitator of the present invention comprises separate primary ice stirring member and a separate, secondary ice stirring member that can be removably joined or held together to the primary ice stirring member, preferably only by ice actions and without the need of fasteners. A locking cap is provided on to the shaft of an agitator motor located in the ice bin. A small fastener could be used to hold the cap to the shaft. The primary member and/or secondary member may provide a hub portion which fits onto the motor shaft used to drive the agitator to locate the agitator on the shaft. While the cap may have a small fastener (10-32 screw), it does not hold the agitator onto the shaft, as this too is accomplished by the ice action acting on the agitator. One realizes this statement is true, as a 10-32 screw is very small and could not by itself accomplish this task.

Further, less material is used to make the multiple-piece agitator of the present invention. For example the elements could be formed from two 21″×3″ (63″×2=126 sq. inches) sheet metal piece, and they would replace the single piece prior art agitator formed from a 16″×16″ (256 sq. inches) sheet metal piece. This represents about a 100% savings (256 sq. inch v.126 sq. inches). The individual pieces of multiple-piece construction agitator are less bulky (more “flat” or two dimensional) and thus also easier and more convenient to store in bulk, as for inventory purposes or in packaging and shipping for replacement purposes, for, as noted above, they do, on occasion, get bent or broken in service. The present invention offers the further advantage that if only a single component is bent or broken, that component can be individually replaced, whereas with the prior art unitary construction, the entire prior art agitator had to be replaced.

### BRIEF DESCRIPTION OF THE SEVERAL VIEWS OF THE DRAWINGS

FIG. 1 is a cross-sectional view of a typical beverage/ice dispenser with an icemaker mounted thereon, but with a prior art agitator of unitary construction showing the restricted service opening.

FIG. 2 is an enlarged perspective view of the unitary constructed prior art agitator shown in FIG. 1.

FIG. 3 is an exploded perspective view of the disassembleable agitator of the present invention and its various elements.

FIG. 4 is a cross-sectional view of the assembled agitator of the present invention shown disassembled in FIG. 3.

FIG. 5 is a view of a dispenser icemaker similar to that FIG. 1, but with the assembled agitator of the present invention therein and showing one dimension of the limited access opening.

FIGS. 6A, B, and C are views similar to FIG. 5, but with the agitator of the present invention, illustrating how the disassembled components of the agitator of the present invention can be removed through the limited service opening for cleaning of the agitator or bin, and repair or replacement of the agitator.

### DESCRIPTION OF PREFERRED EMBODIMENTS

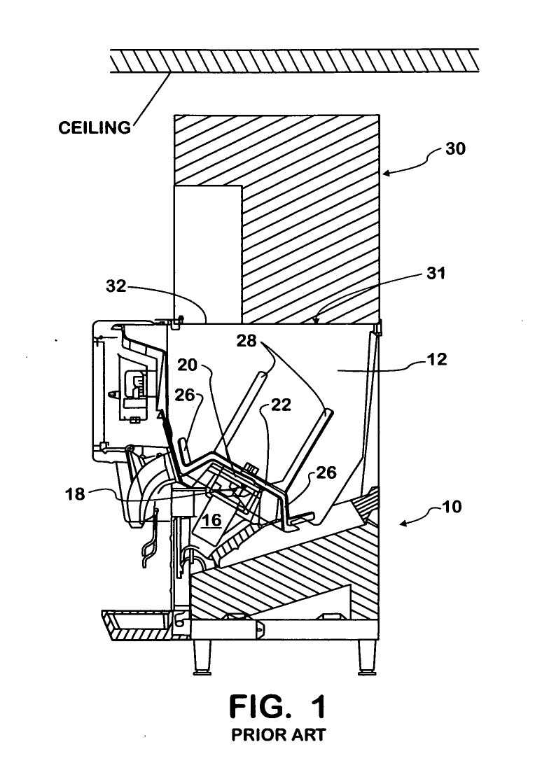

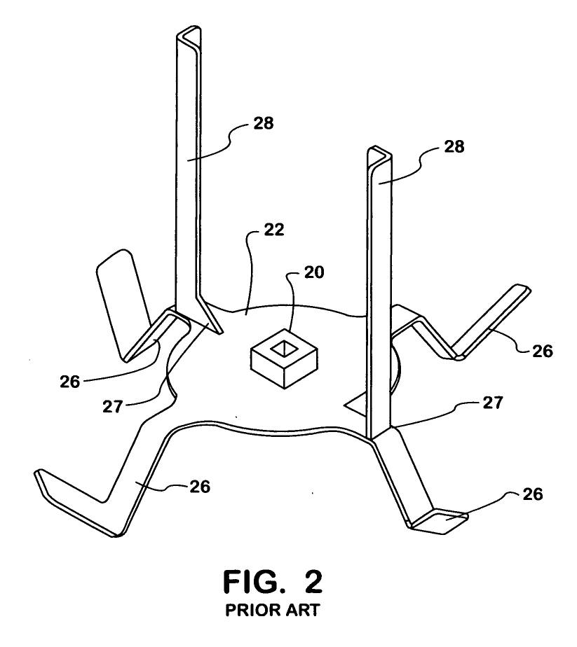

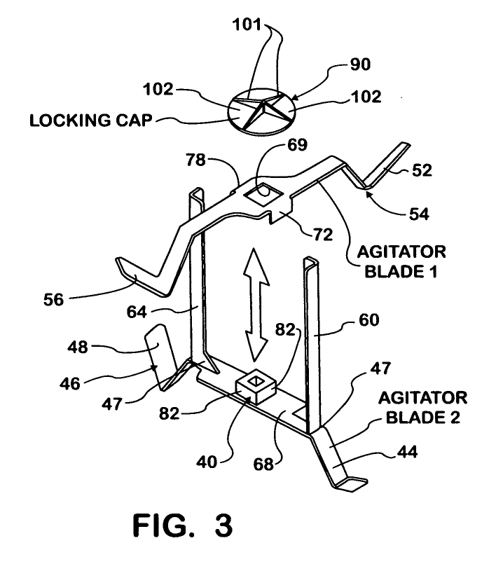

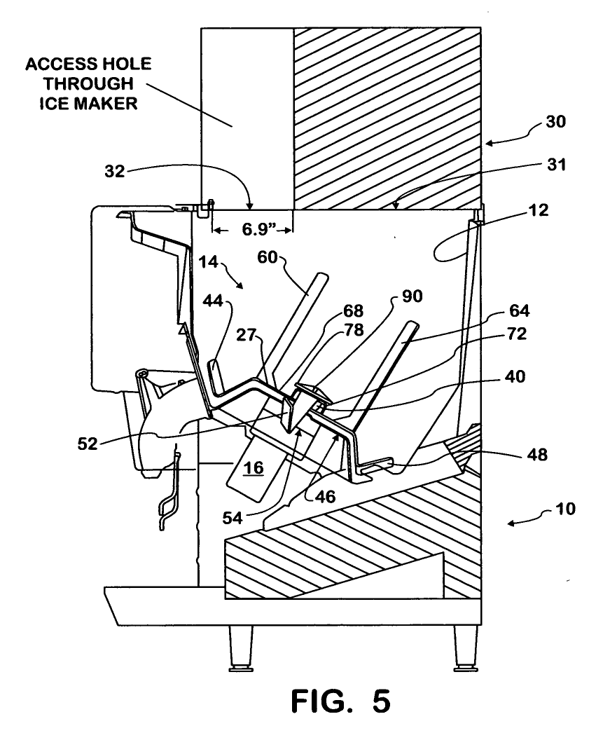

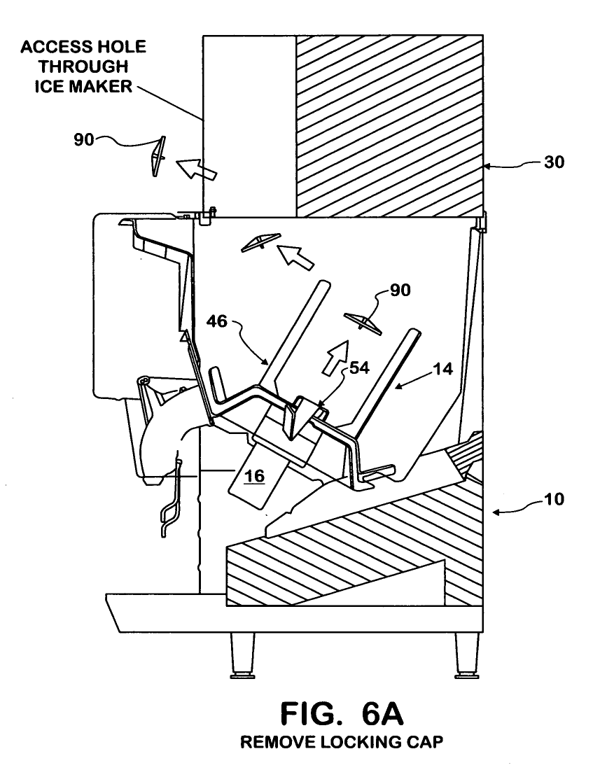

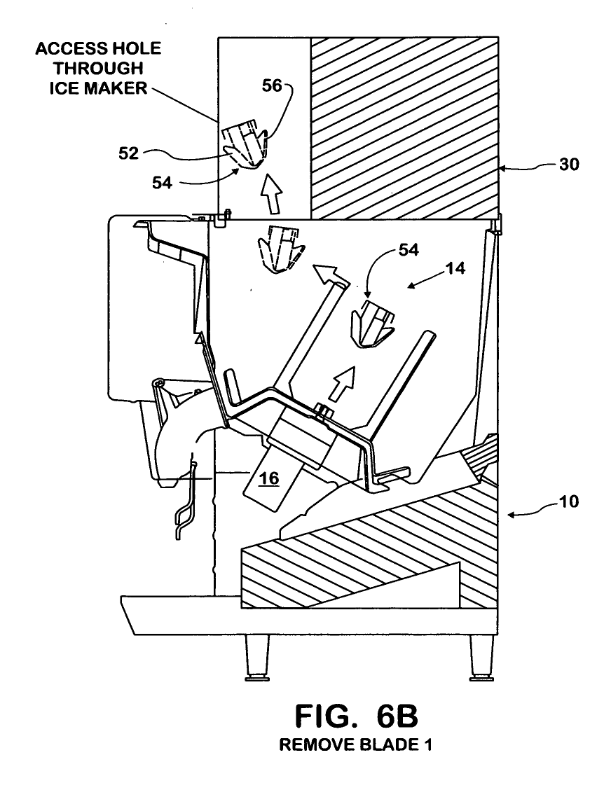

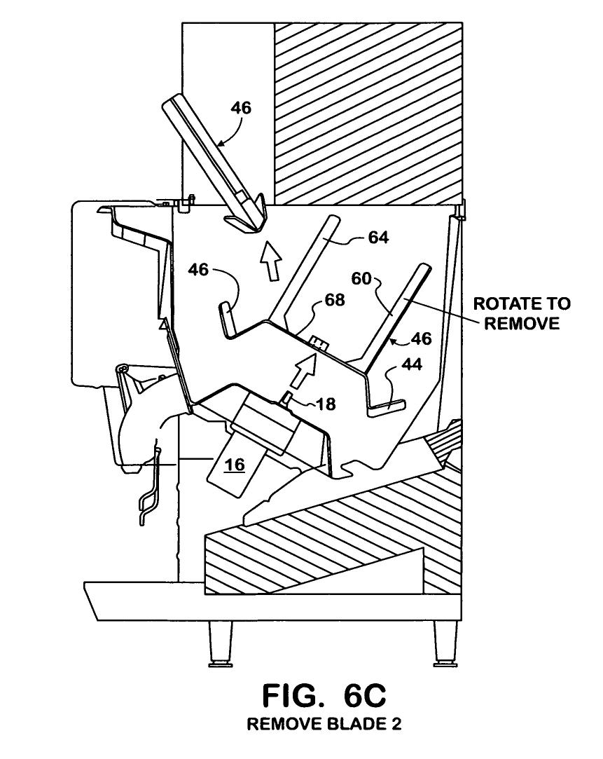

Referring to FIGS. 1, 3, and 5, and 6A, B and C, a conventional ice dispenser 10 is shown, which includes an ice bin 12 therein. An agitator 14PA (Prior Art) in FIGS. 1 and 2 and agitator 14 of the present invention in FIGS. 5 and 6A, B and C shown therein. The ice dispensers include a motor 16 with a shaft 18 to drive the agitator 14PA or 14. The ice dispenser could also be part of a beverage dispenser which dispenses both beverage drink and ice, usually for a drink.

As shown in FIGS. 1 and 2, the ice dispenser has a prior art agitator 14PA which typically is unitary and has a hub 20, which could be on a circular base 22, from which extends two relatively vertical ice stirring arms 24 (say secured by welding) perpendicular to the base 22 and four generally relatively horizontally extending further ice stirring bent arms 26. The prior or agitator 14PA (except for the verticals 24) is generally formed from a single piece of metal of a non-rusting nature, such as stainless steel or aluminum. The stock from which the agitator is formed is heavy say from ⅛ to ½ inches thick, with about ⅜ inch thick being preferred and once formed, generally will hold its shape even when breaking up massive ice freeze ups in the bin. Alternatively, some of the agitators 14PA are made unitary by welding all their components together.

As shown in FIG. 1 and FIG. 2, the agitator 14PA is installed in the ice bin 12 on the motor shaft 18 and is rotated by motor 16. Usually the ice dispenser is fitted with an icemaker 30 there above, which can gravity-feed formed ice into the ice bin 12. The presence of the icemaker 30 on top of the dispenser 10 and ice bin 12, greatly limits access to the open top 31 of the ice bin 12 and the agitator 14PA therein. See FIG. 5. To assist in carrying out required cleaning or maintenance of the ice bin and agitator, usually some form of limited size access opening 32 is provided. The access opening generally is large enough to permit with difficulty cleaning of the ice bin, but is not large enough to permit removal of the agitator 14PA from the ice bin, either for cleaning or repair. The length, width and height of the prior art agitators are such that they are larger than the access openings and prevent the agitator's removal. If an icemaker 30 is mounted on the top of the dispenser 10 and its ice bin 12, the best that can be done is the agitator 14PA might be slipped off the motor shaft 18, and maneuvered around inside the ice bin 12 to help give access to clean the ice bin and/or agitator. The rigid, unitary prior art agitator 14PA is just too large to be removed through the access opening 32 when it is covered by the icemaker 30.

Sometimes where there is a close ceiling 33 (See FIG. 1), it can limit the ability to raise the icemaker 30 above the ice bin 12. In some installations, the ceiling height could even limit selection of the dispenser/icemaker combination as the combined height would have to fit below the ceiling. In such circumstances with a ceiling height restriction, to repair or replace a damaged prior art agitator 14PA would require the icemaker to shift the ice maker sideway and lift it from the dispenser before the agitator could be removed.

In order to give reasonable area and volume sweeps, the prior art agitator 14PA has as large a height, width and length or diameter close to but smaller than that of the bin in which it moves to cover as large an area and volume of that ice bin as possible. These dimensions, in turn, along with the agitator's unitary construction, make even maneuvering a dismounted unitary icemaker more difficult, as there is very little space to maneuver the agitator trapped in the bin.

In the present invention, instead of a unitary agitator like 14PA, a disassembleable agitator 14 made of several elements is used. The agitator 14 of the present invention is made up of a hub 40, which fits onto the motor shaft 18, and includes at least a first pair of ice stirring arms 44 and 48 on an element 46 which can be mounted to or carry the hub 40, and at least an additional pair of ice stirring arms 52 and 56 mounted on second element 54 and extending in different directions than the at least first pair of arms 44 and 48. Now as an alternative, the hub could have been formed instead on element 56. However, each of the components are separable and small enough, when the agitator is disassembled, to permit each of the elements thereof to be removed from the ice bin 12 through the access opening 32, even if with an ice maker 30 is in place on top of the dispenser 10. Each of the elements 46 and 56 tend to be more two dimensional and have a third dimensional much smaller than its other two dimensions. Thus, construction tends to give a “flat” element which can be maneuvered and removed through the access opening.

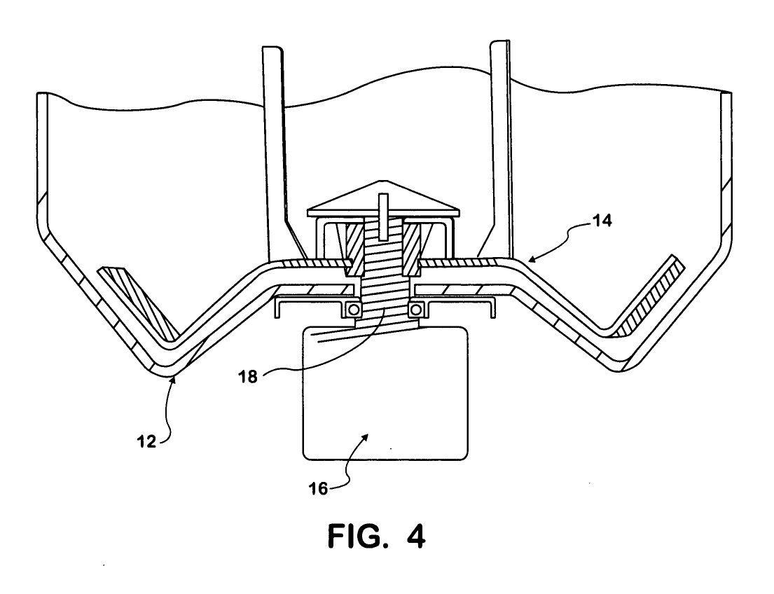

As shown in FIG. 6, the agitator on one or the other of the arm carrying elements can also carry a pair of generally perpendicular or vertical stirring members 60 and 64, which can be attached or welded 47 to one or the other of the elements 46 and 54. In this instance the vertical stirring members 60 and 64 are on the same element carrying arms 44 and 48 and the hub 40 and in the form of a generally radially extending, diametrical base or plate 68. As is shown in FIG. 4, the plate 68 and its hub 40 is non-circular, here square, and can extend into a cooperating non-circular, in this instance large square, opening 69 to drive the same. To help locate the second set of arms on the hub there are a pair of short stabilizing legs 72 and 78 that abut the plate 68 and closely fit or are juxtaposed the vertical sides 82 of the hub 40. This construction helps prevent wobble of the arms.

To locate the agitator 14 on the motor shaft 18, a locking cap 90 is provided, the cap having a small threaded portion 94 which cooperate with another threaded portion 98 on the motor shaft 18. This cap can be similar to that used with prior art agitators.

As shown in FIG. 5, the various elements of the agitator 14 are stacked on the motor shaft 18 with the hub 40 engaging a non-circular portion 99 of the motor shaft 18, and the second set of arms engaging the exterior 100 of the hub 40, with the locking cap 90 then being threaded into the motor shaft. In this instance, the cap has a male threaded portion while the shaft has a female thread. The rotation of the motor and hand of the thread are selected so that rotation tends to tighten the cap onto the shaft, as is conventional. Now a reverse construction could also be used, with a male thread on the shaft and the cap having a cooperating female thread or nut.

Now the upper portions of the cap 90 is made large say 3 to 3.5 inches in diameter or to 3.5 inches square and may have ridges 101 or indentations 102 to assist manually gripping the cap to remove or install it by hand without the need of a tool. Alternatively, a tool style construction could be used such as with a socket or wrench. The cap also helps keep ice or moisture from reaching the top of the motor shaft. Now the cap does not hold the agitator onto the motor shaft, nor the agitator parts together, as it is recognized that the small 10-32 screw used would be totally incapable given the ice loads imposed on the agitator as it turns in the ice. The function of this screw is secure the cap to the motor shaft and assure the agitator blades do not get pushed off the shaft by vibration of the ice moving between the hopper wall and the agitator blades. The design is such that these loads are small. Instead, the agitator components are formed so that the first element and second element are held together on the hub, and the hub is held on the motor shaft by the ice acting on the individual parts of the agitator as the latter is rotated by the motor.

As is shown in FIGS. 6A, B and C, the agitator 14 element may be disassembled into its individual pieces, and each removed indicated by the heavy arrows, through the access opening 32 from the ice bin 12 to be cleaned, repaired, serviced or replaced. Also, with the agitator 14 out of the ice bin 12, the latter is much more easily serviced. Following the steps in FIGS. 6A, B and C, permit and illustrate removal of the agitator, and its reinstallation and assembly would be in a reverse order of FIGS. 6C, B and A.

With the agitator 14 of the present invention there is no need to lift off an icemaker to service the ice bin and agitation. Thus, maintenance is more easily and safely carried out.

A further advantage is that the individual agitator components will fit within a conventional or commercial size dishwasher, and can be more easily cleaned therein.

While one form of agitator of the present invention is shown, it should be understood that the agitator overall appearance could be different and similar to that of any prior art unitary agitator, except that the agitator would be made of several pieces and disassembleable. Preferably the prior art overall appearance could be altered to the extent necessary to keep the individual pieces of the agitator held to each other and the hub or the motor without the need for fasteners but solely by ice action.

While a preferred embodiment of the present invention has been disclosed and described, it should be understood that equivalent elements and steps of those disclosed herein will all within the scope of the following or to be later added claims.

What we claim is:

1. A disassemblable, removable agitator for an ice dispenser, for use with the ice dispenser, having a hopper for receiving ice, said ice dispenser having a limited service opening, comprising a multiple piece agitator, said agitator when assembled being larger than the limited service opening, and each of said multiple pieces being small enough when disassembled to be removed from said limited service opening.

2. A disassemblable, removable agitator as in claim 1, wherein said multiple piece agitator comprises a first bar and a second bar removably attachable to said first bar.

3. A disassemblable, removable agitator as in claim 2, wherein one of said first and second bars has a hub, said hub being adapted to be rotatably driven by a shaft, and the other of said second and first bars being engageable with said hub.

4. A disassemblable, removable agitator, as in claim 2, further comprising a cap, said cap fitting over said first and second bars.

5. A disassemblable, removable agitator as in claim 4, wherein said first and second bars are adapted to receive a shaft for rotating the first and second bars, and said cap is adapted to engage said shaft.

6. A disassemblable, removable agitator as in claim 2, wherein said first and second bars are shaped to prevent ice from separating the first and second bars as they rotate through ice.

7. A disassemblable, removable agitator as in claim 1, wherein each of said multiple pieces of said agitator is no larger than 16 by 14.25 by 3 inches.

8. A disassemblable, removable agitator as in claim 1, wherein one of said first and second bars is generally radial having at least two generally radially extending arms, and the other of said first and second bars extends generally horizontally and carries at least two opposed vertical elements.

9. A disassemblable, removable agitator as in claim 8, wherein one of said first and second bars carries a hub having one portion adapted for engaging a shaft for turning said agitator, and another portion for engaging the other of said first and second bars.

10. A disassemblable, removable agitator as in claim 9, wherein said hub one portion thereof and said another portion thereof are non-circular.

11. A disassemblable, removable agitator as in claim 10, wherein said hub, one portion thereof and said another portion thereof is square.

12. A disassemblable, removable agitator as in claim 10, wherein said hub is on said first bar, and said second bar has a non-circular opening to receive said another non-circular portion of said hub.

13. A disassemblable, removable agitator as in claim 12, wherein said hub, one portion thereof, another portion thereof and said opening in said second bar are square.

14. The combination comprising an icemaker disposed on top of an ice dispenser and disassemblable, removable agitator for use in said ice dispenser, said ice dispenser having a hopper for receiving ice, said icemaker and ice dispenser having a limited service opening for said ice hopper and said agitator, said multiple piece agitator when assembled being larger than the limited service opening and operating in said hopper to deliver ice, and each of said multiple pieces of said agitator being small enough when disassembled to be removed from said limited service opening formed by said icemaker and dispenser.

15. The combination of claim 14, wherein said multiple piece agitator comprises a first bar and a second bar removably attachable to said first bar.

16. The combination as in claim 15, wherein one of said first and second bars has a hub, said hub being adapted to be rotatably driven by a motor shaft in said hopper of said ice dispenser.

17. The combination as in claim 16, further comprising a cap, said cap fitting over said first and second bars.

18. The combination as in claim 15, wherein said first and second bars are shaped to prevent ice from separating the first and second bars as they rotate through ice in said hopper of said ice dispenser.

19. The combination as in claim 15, wherein each of said multiple pieces of said agitator is no larger than 16 by 14.25 by 3 inches and said limited service opening between said icemaker and said ice dispenser is large enough to not therethrough permit the assembled agitator to pass, but is large enough to permit each of said disassembled agitator pass therethrough.

20. The combination as in claim 19, wherein one of said first and second bars is generally radial having at lest two generally radially extending arms, and the other of said first and second bars extends generally horizontally and carries at least two opposed vertical elements.

21. The combination as in claim 20, wherein one of said first and second bars carries a hub having one portion adapted for engaging a motor shaft extending through said the hopper wall of said hopper of said ice dispenser for turning said agitator, and another portion for engaging the other of said first and second bars.

22. The combination as in claim 21, wherein said hub one portion thereof and said another portion thereof a portion of the shaft engaging the hub are non-circular.

23. A disassemblable, removable agitator, as in claim 3, comprising a cap, said cap fitting above said first and second bars, said first and second bars are adapted to receive a shaft for rotating the first and second bars, and said cap is adapted to engage said shaft, said first and second bars being shaped to prevent ice from separating the first and second bars as they rotate through ice, each of said first and second bars of said agitator being no larger than 16 by 14.25 by 3 inches, one of said first and second bars being generally radial having at least two generally radially extending arms, and the other of said first and second bars extends generally horizontally and carries at least two opposed vertical elements, one of said first and second bars carries a hub having one portion adapted for engaging a shaft for turning said agitator, and another portion for engaging the other of said first and second bars, said hub one portion thereof and said another portion thereof are non-circular.

24. The combination as in claim 15, wherein said first and second bars are shaped to prevent ice from separating the first and second bars as they rotate through ice in said hopper of said ice dispenser, each of said multiple pieces of said agitator is no larger than 16 by 14.25 by 3 inches and said limited service opening between said icemaker and said ice dispenser is large enough to not permit the assembled agitator to pass there through, but is large enough to permit each of said disassembled agitator pass there through, one of said first and second bars is generally radial having at lest two generally radially extending arms, and the other of said first and second bars extends generally horizontally and carries at least two opposed vertical elements, one of said first and second bars carries a hub having one portion adapted for engaging a motor shaft extending through said the hopper wall of said hopper of said ice dispenser for turning said agitator, and another portion for engaging the other of said first and second bars, said hub one portion thereof and said another portion thereof a portion of the shaft engaging the hub are non-circular.

25. The method of servicing a multipiece agitator in a hopper for an ice dispenser having a limited size access opening wherein said multipiece agitator when assembled is too large to pass through said limited size access opening, comprising the steps: disassembling the multipiece agitator in said hopper, removing in sequence each piece of said multipiece agitator from said hopper through said limited size access opening, servicing at least one of said hopper and multipieces of said agitator, returning each of the multipiece agitator into said hopper through said limited access opening, and assembling the multiple pieces of said agitator in said hopper.

26. The method of servicing as in claim 25, wherein the step of servicing comprises sanitizing one of said hopper and agitator pieces.

27. The method of claim 26, wherein the step of servicing comprises sanitizing both of said hopper and agitator.

28. The method of claim 25, wherein the step of servicing comprises repairing one or more pieces of said multiple piece agitator.

29. The method of claim 25, wherein the step of servicing comprises replacing one or more pieces of said multiple piece agitator.

30. The method of claim 25, comprising the step of forming the limited size access opening of a size that will let an assembled agitator pass there through but of a size that permits a disassembled piece of the multipiece agitator of 16 by 14.25 by 3 inches or smaller to pass there through.

31. The method as in claim 26, wherein the step of sanitizing includes the step of sanitizing one or more of the pieces of the multiple piece agitator in a dishwasher.

32. The method as in claim 31, including the step of washing all of the disassembled pieces of the multiple piece agitator in the dishwasher.

33. The method as in claim 25, comprising the step of forming the limited size access opening between the ice dispenser and an icemaker.

34. The method as in claim 33, comprising supplying ice for the multiple piece agitator to said hopper of said ice dispenser from said icemaker.

35. The method of claim 25, wherein the step of disassembling comprises removing a cap from a shaft during said agitator, removing a first bar off of a second bar, removing the second bar having a hub off of the shaft, the steps of removing comprising sanitizing said hopper, replacing any of said first and second bars in need of replacement, repairing any of said first and second bars in need of repair, sanitizing the first and second bars and caps to be installed in the hopper, and the step of returning includes the step of installing the second bar and hub onto the shaft, installing the first bar on the second bar, the step on installing the cap above the first and second and installing it on said shaft.
